(19) United States
(12) Patent Application Publication
(10) Pub. No.: US 2011/0164779 A1
(43) Pub. Date: Jul. 7, 2011

(54) ELECTRONIC MEDIA PLAYERS AND SPEAKERS FOR USE WITH INFANT CARRIERS

(76) Inventor: Clare Elizabeth Cassidy, Wigan (GB)

(21) Appl. No.: 13/062,753

(22) PCT Filed: Sep. 9, 2009
(86) PCT No.: PCT/GB09/02141

§ 371 Date: Mar. 8, 2011

(30) Foreign Application Priority Data
Sep. 10, 2008 (GB) 0816512.8

(51) Int. Cl. H04R 1/02

(52) U.S. Cl. 381/389

(57) ABSTRACT

An infant carrier such as a pushchair, pram or buggy comprises an electronic media player (e.g. an MP3 player or a video player) and one or more speakers that are spaced from, but operably connected to said media player. The one or more speakers are not integrated into the infant carrier but are releasably attached thereto. The speakers can be in the form of fictional or non-fictional characters and may have their output limited to minimise risk to an infant's hearing. The speakers and media player can be easily removed when not required and can also be easily adjusted in situ. If desired, the speakers and/or media player may be housed in pockets of a rain cover or releasably attached to the rain cover. The invention can also be applied to carriers/vehicles other than infant carriers.

The present invention relates to electronic media players and speakers for media players. More specifically, it relates to electronic media players for use with infant carriers, such as pushchairs, prams and the like. It also relates to speakers for use with such media players.

Music has been used for many generations to entertain infants. It is also useful for soothing infants or getting then to sleep. This has been done traditionally for many hundreds of years by parents singing lullabies to their children.

It has also been since by using music boxes. These were originally in the form of mechanical, wind up devices but many electronic music boxes are now known.

Electronic toys that play music or sounds are also well known. Indeed there is a large variety of such toys and they have been known for many decades.

Some of these toys may be used to stimulate learning or brain development. For example they may be used to assist in the development of language. This can be done by using the toys to play nursery rhymes, speech etc. Some research also indicates that playing classical music such as Mozart to an infant can enhance learning or intelligence. Thus there is a wide range of possibilities.

A recent addition to the range of toys that play music or sounds is known as the “I-Teddy”™. This consists of a teddy bear with an MP3 player and speakers integrated within it. This has attracted much publicity in the UK following a presentation on the television program “Dragon's Den”.

Whilst toys that play music or sounds are very popular, they can have various disadvantages in practice. One is that such toys can often be thrown out of a pushchair or other infant carrier by an infant in the carrier. Thus the toys can be lost, damaged or dirtied. In any event it is inconvenient for a parent to have to pick up and reposition the toy. This can be a particular problem if the infant is in a disgruntled or in playful mood and wishes to repeatedly throw a toy out of the carrier, even when it is replaced by an adult.

A further disadvantage is that it can be difficult to position the toy within an infant carrier to ensure an appropriate level of sound. Indeed even if the toy is initially placed at a desired location within the carrier, often the toy will fall within the carrier so that it cannot be easily heard by the infant. This may cause upset to the infant, especially if the infant enjoys listening to particular sounds or music from the music from the toy. Indeed a parent may also wish to listed to sounds emanating from the toy so as to interact with the infant, e.g. to join in along with a song or nursery rhyme.

There can also be major a disadvantage if the toy is positioned too close to an infant. Some toys can be noisy and there can be a concomitant risk of damage to the hearing of an infant if the toy or a sound emitting part thereof is located too close to the ear of the infant.

Indeed infants have narrower ear canals than adults, with the result that sounds entering the ear of an infant can be significantly amplified relative to sounds entering the ear canal of an adult. The consequence of this is that damage to the inner ear can be caused at much lower noise levels than would cause damage to the hearing of an adult or an older child. In some cases such damage can be permanent. However, even temporary damage can be of concern to the parent and can be distressing to the child.

The risk of hearing damage is therefore is real and is accentuated by the fact that infants often wish to hold toys very close to them. Thus a toy that emits noise may be held very close to the ear of an infant or may end up in this position. Many adults are simply not aware of the associated risks.

Indeed even if an adult using an infant carrier in which a toy that emits sounds is present is aware of the risks, it is usually not practical to continuously monitor the infant and an adult will therefore not necessarily notice when a potentially dangerous situation arises. The adult many be concentrating at least for a period on pushing or manoeuvring the infant carrier, on avoiding traffic, on shopping, on talking to others, etc. In any event, the toy may be out of the line of sight of a parent pushing the infant carrier. Thus in practice, the adult may have little control over what the infant in the carrier does with a toy placed in the carrier.

It is also known to position devices known as musical mobiles above an infant carrier. Musical mobiles are typically fairly large and cumbersome and are generally mounted to a ceiling. As the mobile device moves (typically in a circular manner around a fixed axis) this entertains/soothes the infant. This is accentuated by music from the device, which is generally synchronised with said movement.

Musical mobiles are commonly used in infant's bedroom or play areas and can be useful for distracting a child when a parent wishes to move away for a period e.g. to rest, to perform household tasks etc. There is also not usually a major risk of damage to hearing associated with such devices (unless they are set at very loud levels) because they tend to be positioned some distance away from an infant's head. However, once the infant carrier is moved away from the musical mobile, the benefits of the mobile are lost.

There are some examples of infant carriers that include media players integrated into the design of the carrier. Thus the media player is transported along with the infant carrier and is available for use when the infant is within the carrier.

For example, WO 03/078228 relates to a pram with an integrated music playback system. Here there is no major risk that the system will be thrown out of the pram by an infant. However this approach requires the pram to be specially designed, which can significantly increase costs and reduce flexibility in design. In the example shown in WO 03/078228 speakers are integrated into the side walls of the pram and are covered by an inner lining. It is also necessary to route cables that lead to the speakers through the fabric of the pram and to provide specific apertures for the wiring.

GB 2345596 discloses an alternative approach in which a pram or pushchair incorporating a generator is provided. The generator is driven by one or more wheels and is coupled to the wheels via gears, pulleys, chains or sprockets. The generator charges a capacitor that contains rechargeable batteries. The capacitor can be connected to external devices including fans, heating units, radio cassettes, or CD players. A special waterproof and insulated casing is integrated into the design of the pram for holding the external device and for providing electrical connections. Thus this device is relatively complex and requires major modifications to an infant carrier. It also makes the infant carrier harder to push given that energy is used in charging the capacitor. A further disadvantage as with any such system is that faults can arise resulting in lack of charge or reduced charging. Indeed even if there are no faults then, unless the system is charged, an external device attached to and requiring power will not function. This can be a major problem if for example the pram or pushchair is left stationary for long periods.

U.S. Pat. No. 5,938,216 describes a baby carriage with a sound and illumination system. It utilises a magnetic switch to drive a control circuit. The magnetic switch is said to be fixed to the leg of a frame of the carrier and to be coupled to the control circuit through a lead wire. A magnet is fixedly secured to the interior of a wheel of the carriage. When the wheel rotates it activates the magnetic switch thereby allowing the control circuit to be operated. This is said to cause a speaker to operate different rhythms. The speaker is shown in fixed low position on a leg of the frame and is connected via a wire that runs down the leg to the magnetic switch.

U.S. Pat. No. 4,629,950 describes a variable automatic forward/reverse control device for an unattended baby cart that includes a power source and a drive motor. In some cases the power source may be connected to a lamp or a music device. Again therefore this is a complex arrangement that requires special modification of an infant carrier.

JP 6008826 shows a baby carriage with an electronic musical instrument integrated into the carriage. The carriage comprises an element cluster that can be operated by the baby and can generate a sound via a speaker. The speaker is integrated into the fabric of the baby carriage at a fixed position and is connected thereto by an integrated wiring system.

U.S. Pat. No. 5,645,204 describes a relatively crude device in which an entertainment unit is simply encased within an encasement box and attached to a transport carrier such as a pushchair. The box shown is large and appears very cumbersome. It is indicated that it may include a TV or radio. The entertainment unit is said to be self contained and it is emphasised that no headphones are needed for it to be heard, even outdoors. It appears that it is designed to play at fairly loud levels and that it is clear that there is no need to connect speakers to be attached to the entertainment unit

It will be appreciated from the foregoing analysis that although electronic players have been used in infant carriers for some time, none of the existing arrangements are satisfactory. Some require actuation or charging via wheels of the device. Most are integrated into the design of infant carriers and cannot be used with standard baby carriers unless these are extensively modified. Some cannot be easily be controlled or adjusted by an adult using the carrier to transport an infant. None address the problem of minimising or reducing the risk of damaging the hearing of infant. Indeed most appear to use standard speakers that would be used for adults.

The present invention aims to overcome or alleviate one or more of the disadvantages of prior art systems.

According to the present invention there is provided an infant carrier that comprises an electronic media player and one or more speakers that are spaced from but operably connected to said media player; wherein said one or more speakers are not integrated into the infant carrier but are releasably attached thereto.

Thus the infant carrier need not be specially adapted for receiving speakers and/or media player.

Preferably the maximum noise level that can be provided by said speakers to an infant being transported by said carrier does not exceed 85 decibels. More preferably it does not exceed 80 decibels. Most preferably it does not exceed 75 decibels (e.g. it does not exceed 70 decibels. or it does not exceed 65 decibels).

Low output speakers can be used for this purpose. Alternatively, higher outputs speakers can be provided but can be muffled or can have their output limited e.g. by volume limiters or stops. Noise output can be checked if desired using a noise meter. Indeed such a meter may optionally be provided together with one or more speakers and a media player for use with the present invention.

The speakers are preferably releasably attached to the infant carrier by using one or more of the following releasable attachment means: clips, clamps, ties, straps, bands, hook and eye fasteners, magnets, releasable press or push fittings.

Desirably the speakers are releasably attached via quick release means. More desirably they are releasably attached in a manner facilitating single handed release of each speaker.

A quick release clip may be used, if desired. The clip may be spring-loaded or otherwise biased towards a closed position but may be released by applying pressure against the direction of bias. For example, a bulldog type clip can be released by applying pressure to move two inner faces of the clip apart. Preferred clips are resiliently deformable.

The attachment means may be specifically shaped for attachment to frame or a handle of the carrier. Thus for example it may be arranged to fit totally or partially around part of said frame or handle. Alternatively, the attachment means may allow releasable attachment to a part of a seat or upholstery of the infant carrier.

Thus the one or more speakers (which preferably have in-built attachment means) can be positioned in a wide variety of positions. They may even be attached to a hood of the carrier, in addition to the alternatives discussed above.

In a preferred aspect of the invention, the speakers and/or media player are positioned at a height that is not below the level of a head of an infant transported by said carrier. Thus the speakers are preferably at the same level or above the level of the head of an infant being transported by said infant carrier

More preferably the speakers and/or media player are positioned at a height that is above the level of a head of an infant transported by said carrier. Most preferably the speakers and/or media player are positioned to allow the infant to hear sounds and/or to see images but to be out of reach of the infant, whilst the infant is being transported.

It is however preferred that the one or more speakers and/or the media player are positioned to be readily accessible to a person using the infant carrier to transport the infant. Preferably therefore they are located at or close to the handles of the carrier. For example they many be located less than a meter, more preferably less than 75 cm or less than 50 cm from the handles. Most preferably the are located less than 25 cm from the handles

In a preferred embodiment the speakers are in novelty form. Thus they may for example be in the form of some other item and need not be immediately recognisable as speakers. Thus they can be disguised.

The speakers may for example be in the form of one or more of the following: a fictional or non-fictional character; a sporting item, emblem or badge; a toy; an animal or plant; or a vehicle. More specifically the may be in the form of one or more of the following: a fairy, a doll, a teddy bear, a monster, a cowboy, an indian, a soldier, football, a rugby ball, a cricket ball, a flower, a car, a plane, a boat. These are of course only examples and there is a wide range of other possibilities. Indeed it is also possible to provide a plurality of speakers where the speakers or at least some of them are in different forms.

Pairs of individual speakers that have strong associations may for example be used (e.g. pairs of speakers in the form of a cowboy and indian, a prince and princess, a cat and a mouse, etc., may be used). However pairs of speakers need not necessarily be in the form of commonly associated characters.

In some cases the novelty speakers may be provided with a range of different covers that can be swapped. This allows the appearance of the speakers to be changed over time. For example, one day a speaker in the form of a cowboy may be used and another day a speaker in the form of an Indian many be used. This can be easily achieved, e.g. by using removable press-fit or push-fit covers, removable clips or fasteners, etc. There is a wide variety of possibilities and all are within the scope of the present invention.

Indeed the speakers per se are within the scope of the invention and the invention is therefore not limited to an infant carrier with one or more speakers attached.

The speakers may have one or more of the features of speaker discussed herein. Preferred speakers comprise a releasable attachment means that is spring loaded or is otherwise biased to a closed position. If desired the speakers may be in the form of novelty speakers, as discussed above.

The speakers may be operably connected to the media player by one or more wires. Here it is preferred that the wires do not pass through specially adapted receiving channels or apertures of the infant carrier. Thus an unmodified standard infant carrier can be used, unlike the situation with many other systems.

It is of not however essential to use speakers that are connected to the media player by wires. The speakers may be operably connected to the media player wirelessly, e.g. by Bluetooth™ technology.

Desirably the one or more of the speakers are spaced from the media player by at least 10 cm, e.g. by at least 20 cm or at least 30 cm. Spacing of speakers can improve sound quality, can reduce interference and can improve stereo effects.

In some cases it may be desired to locate one speaker closer to a person pushing the infant carrier than the infant and another closer to an infant being transported than to the person pushing the infant carries. This can allow the media player to be easily heard by both individuals, even at very low sound levels.

In a preferred embodiment the media player is not charged by, or actuated by, the action of wheels of the carrier. Similarly it is preferred that the infant carrier does not include a generator or a drive motor. Thus an infant carrier without complex or expensive wheel modifications can be used.

Desirably the media player has its own internal power source. Preferably it is battery powered.

The one or more speakers may also have their own power sources (e.g. batteries) or may run off a power source provided by the media player. Of course, if batteries are used then they may be rechargeable, if desired. It is well known for example to provide MP3 and MP4 players with rechargeable internal batteries.

Like the speakers it is preferred that the media player be releasably attached to the carrier. The same or similar releasable attachment means may be used.

Alternatively, the media player may be provided in a container that may itself be releasably attached to the infant carrier. For example a bag or holder that comprises the media player may be provided. This may be tied, fastened, clipped, clamped or otherwise releasably secured to the infant carrier.

In a still further alternative the media player is housed in a pocket or pouch already provided by an infant carrier. Pockets or pouches are commonly used in existing carriers. They may be used fro example to hold wipes, dummies, bottles or other items for infants. They can easily be used to hold a small or medium sized media player without a need for major modification. Thus, again, there is no need to change the design of the infant carrier in order to accommodate the present invention.

It is also noted that many infant carriers are provided with rain covers.

In one aspect of the present invention a compartment built into a rain cover may be provided for the media player or the rain cover may comprise means for releasably attaching the media player thereto. This can be particularly useful if the media player shows images/video since it may be positioned to allow ease of viewing by an infant in the infant carrier.

If desired, the rain cover may also comprise one or more pockets for one or more speakers, or may comprise means for releasably attaching one or more speakers thereto.

Turning now to media players for use with the present invention, they can be anything suitable for playing electronic media.

A media player may, for example, be an audio player and/or a player of visual images. Thus, for example, it may be a DVD player, a video player, a portable television, a radio, an MP3 player, an MP4 player, a CD player, a games player, etc.

Preferably the media player is a digital media player. More preferably it comprises an MP3 or MP4 player, although any format is possible and formats may of course evolve over time.

Most preferably it includes a screen or display. The screen may for example be used for showing digital or analogue images, although digital images are preferred.

If a screen is provided it may optionally be one where the position of the screen is adjustable for ease of viewing by the infant and or by a person pushing and/or using said carrier. Thus, for example, the screen may be supported by a flexible or adjustable arm or other support.

Large, medium small or small screens may be used. A wide range of media players with different size screens are available. In practice portable devices screens are preferred, especially ones that can be easily stowed in a rucksack, handbag or even a purse The media player may even include, or be operably connected to, a receiver for a given signal, (e.g. a radio or TV receiver). Such receivers are well known and can be integrated into small devices. Digital receivers are preferred. Indeed some receivers can even be provided as USB devices or “dongles” that may plug into a media player. If necessary, the media player may include, or be operably connected to, an aerial or other means for improving reception of a signal. An aerial may even be releasably attached to the carrier and operably connected to the device (although this is less preferred).

In a further embodiment the media player may be set up to receive internet content. Preferably it can do this wirelessly (e.g. by using Bluetooth™ technology). It may include, or be operably linked, to a wireless modem or wireless transmitter. This is of course already the case for many mobile phones, which may incorporate media players.

Indeed a wide range of other devices incorporating media players may be used. These can include for example multifunctional devices, handheld devices, etc. Such devices can be obtained from technology companies such as Archos, Palm, Apple, Microsoft, Psion, Acer, Asus, etc.

In some cases it is possible to receive internet content without even needing to pay for internet access. This is the case not just for certain cafes and restaurants that provide wireless internet access for free, but also for certain towns and cities. It is of course also the case that many homes and business now provide wireless internet access.

Wireless internet access may be obtained from a free wireless system by using a suitable password if the system is password-protected. Alternatively, a given system may be set up to connect automatically with a given wireless network when it is in range without a user needing to insert a password each time.

The content may be existing content that is downloaded from an appropriate website. For example the BBC i-player may be used to download recent episodes of children's TV programmes from the BBC website. There are many other possibilities, including obtaining material from other content providers (especially content for children), downloading podcasts, etc. Indeed, the I-tunes™ internet library includes some content for children, including free content, educational content and podcasts. Other sources for content are available.

It is even possible to provide content specifically for the present invention. For example a library of digital content for infants/children could be provided and could be accessed via a given internet link. This might for example be called “Buggy Tunes”™. The library may even include items linked to a given children's character or other theme, which may also be reflected in the design of the speakers (see the earlier discussion). Thus for example the library may include songs, stories, rhymes, videos, etc and these might relate to a given character or theme. The library may be freely accessible or may be of restricted access (e.g. to purchasers of a media player and/or speakers of the present invention). For example it may be password-protected; it may require subscription, enrolment, recommendation, payment, etc. Preferably it includes at least some educational content designed to assist an infant in learning (e.g. in improving vocabulary, numeracy, etc). Thus, for example, it may include content relating to the alphabet, to counting, to words or phrases for improving vocabulary, etc.

In some cases the media player may incorporate a recorder (preferably a digital recorder) allowing independent content to be created. Thus, for example a parent or carer may dictate a story, rhyme or lesson; sing a song or lullaby, etc., and use the device to record it. A plurality of such items can be stored to provide a library. The familiarity of the parent's or career's voice can aid in relaxing a child.

It is even possible to provide internet (or other) content by using data-streaming technology. Thus it may be possible to watch or listen to a particular item as it is broadcast. This may be useful for example if it is desired to watch an up to date episode of a children's TV program.

It may also be useful for watching a live sports event, live concert or other live broadcast.

Indeed an adult (e.g. a parent or career) may use such technology to keep up to date with news, weather reports, the latest soap opera, etc, if an infant is asleep. The adult may therefore use the media player to listen or watch items of interest. Thus content that can be played on the media player is not limited to content that may only be of interest to a child or infant.

[It is also possible to use portable TVs as media players. These may have integrated receivers, aerials, etc or may be operably linked thereto, as discussed above. The quality of very small portable TVs has increased significantly over recent decades. Many even include integrated digital tuners—e.g. a Freeview™ or FreeSat™ tuners. Similarly, portable radios may be used as media players, which may again be digital or analogue. Indeed multifunctional devices may be used that provide both TV and radio. Devices providing high definition (HD) output may even be provided. These may be “HD ready” or “full HD devices”.]

Of course in many cases the content may be of interest both to the parent and child. This is especially the case where a parent wishes to use certain content to educate and/or entertain a child. Thus the device can promote useful interaction between the adult and child.

As indicated earlier, it is preferred that the media player is positioned so that controls can be operated by a person pushing or using the infant carrier and cannot be operated by the infant in the carrier.

Alternatively, a code may be provided so that an infant cannot operate the media player, even if close to it, without the code. Security codes are well known for media players and can prevent undesired operation. Volume controls or volume limiters may be provided and may require codes for access.

The invention applies to a wide range of infant carriers. The term “infant carrier” is used herein to include any non-powered carrier designed to be used for transporting an infant. Preferably the carrier is a vehicle. Thus it includes pushchairs, prams and other wheeled carriers for infants.

These may be single carriers or even carriers deigned to carry a plurality of infants. [For example twin and higher carriers are known. If desired a different media player and associated speakers(s) may be provided for each infant in a multiple infant carrier to take into account different tastes, developmental stages, etc. Alternatively, a single media player may be used and may be operably connected to one or more speakers in each section of the carrier.]

Pushchairs are most preferred for use with the present invention. They are also sometimes known as buggies or strollers and are generally used to transport a infant in a seated position. Prams can also be used. They are generally used to transport an infant in a position in which the infant is lying down. (Thus pushchairs are designed to transport infants in a much more upright position than is the case for prams.)

Infant carriers also include carriers that can be attached to bicycles. It is known for example to attach a specially adapted carrier to a bicycle so that an infant can be towed by a cyclist. A further example of an infant carrier is a baby walker. This comprises a frame and wheels and is designed to allow the infant to use his or her legs to propel the carrier. These are often used to assist infants to walk.

It is also important to note that the term “infant carrier” also includes various non-wheeled carriers for infants. It includes carriers in the form of small sleighs or sleds, which can be used to transport infants in countries or conditions where there is snowfall or ice.

The term “infant carrier” also includes removable seats that can be used to secure an infant when being transported in a motor vehicle. These seats are sometimes known as “child seats” and are mandatory in many countries, including the UK, for children below a certain age and/or height. (In some cases such removable seats also functions as seats for pushchairs and are therefore dual purpose.) The term “child seat” is also sometimes used for high chairs or other chairs adapted for infants. The present invention can also be used with these.

Another example of an infant carrier is a carrier that an adult straps around his/her shoulders in order to assist in carrying an infant. Such carriers often appear very similar to rucksacks. They may be framed or frameless. They may include apertures for the infant's arms or legs. Typically they are strapped to the back, front or side of an adult so that the adult can conveniently carry an infant whilst walking. They are referred to herein as portable child carriers.

A still further example of an infant carrier is a cradle. This does not usually have wheels but typically has a handle enabling the cradle to be easily carried. Baby rockers are also included. These can be rocked gently and used to get a child to sleep. Cots may also be included.

Thus many infant carriers can be used. The term “infant” as used herein includes babies, toddlers and young children. Preferably the infant is less than 8 years old. More preferably the infant is less than 6 years old. Most preferably the infant is less than 5 years or less than 4 years old. Infants are of course generally much smaller than adults or young children. They are usually less than 1.25, less than 1.0 metres or less than 0.75 metres tall. Infant carriers are designed and shaped accordingly.

Although it is envisaged that one of the main applications of the present invention is in respect of carriers for infants, it is also possible to use the present invention for carriers for adults or older children. For example it may be used on wheelchairs (or indeed other carriers). It is therefore particularly suitable for sick, elderly, disabled or infirm people of whatever age. Indeed audio or individual output from a media player may be beneficial to such people in recuperation, relaxation, therapy, etc. There is no need for extensive modification of existing wheelchairs, since the system of the present invention can be conveniently attached to and removed from standard wheelchairs when desired. This therefore represents a further aspect of the invention.

Indeed in the invention can be releasably attached to any means of transportation for infants, children or adults. Desirably the means of transportation is a vehicle that is not powered. This therefore includes not only buggies, prams and the like; but also bicycles, tricycles, go-carts, scooters, toy vehicles (e.g. imitation cars, imitation fire engines, etc), etc. Preferred non-powered vehicles are vehicles for infants or children. They may be pushed, or pulled, or even propelled by a child or infant itself. Such vehicles intended for children (including infants) to play on are referred to herein as child vehicles.

The present invention also includes various methods. One such method comprises the steps of:

a) releasably attaching the one or more speakers to a carrier; and
b) releasably attaching the media player, or a container comprising said media player, to the carrier, or inserting the media player in a pouch or pocket provided by said carrier.

Kits are also within the scope of the present invention.

The invention includes a kit comprising one or more speakers, a media player and instructions for use in:

a) releasably attaching the one or more speakers to a carrier and
b) releasably attaching the media player, or a container comprising said media player, to the carrier, or inserting the media player in a pouch or pocket provided by said carrier.

Again it is preferred (although not essential) that the carrier is an infant carrier.

The instructions may further comprise instructions for operably connecting the speakers to the media player if they are not already operably connected (e.g. by using a wired or wireless connection system).

If desired, the kit may further comprise a container for the media player. The container, if present, is preferably suitable for storing both the media player and the one or more speakers when they are not in use. Desirably the container is waterproof or water resistant. Preferably it is transparent or translucent. It may include closure means e.g. a zip fastener, a tie, a drawstring, etc

Most preferably the container comprises means for releasably attaching it to the carrier (e.g. straps, ties, clips releasable clamps, releasable fasteners, etc).

The kit may optionally include a detector of sound levels. For example, it may include a decibel measuring device. The device may be set up to indicate an alarm if the decibel levels exceed a desired level, such as one or more of the maximum desired levels discussed earlier.

If desired a kit may be provided that includes one or more releasable mounts for releasably attaching one or more speakers and or a media player to an infant carrier. For example the mounts may be adapted to attach the speakers and/or media player to a part of the handle, frame, hood, seat, upholstery, or to any other part of the infant carrier. A single mount may even be provided for both the speakers and the media player. (Of course, if desired, releasable attachment means may be integrated into the speaker(s) and/or media player, as discussed herein.)

A further kit of the present invention includes a rain cover for an infant carrier as described earlier that has a compartment for a media player.

Having described the present invention in general terms, it will now be described by way of example only, with reference to the accompanying drawings; wherein:

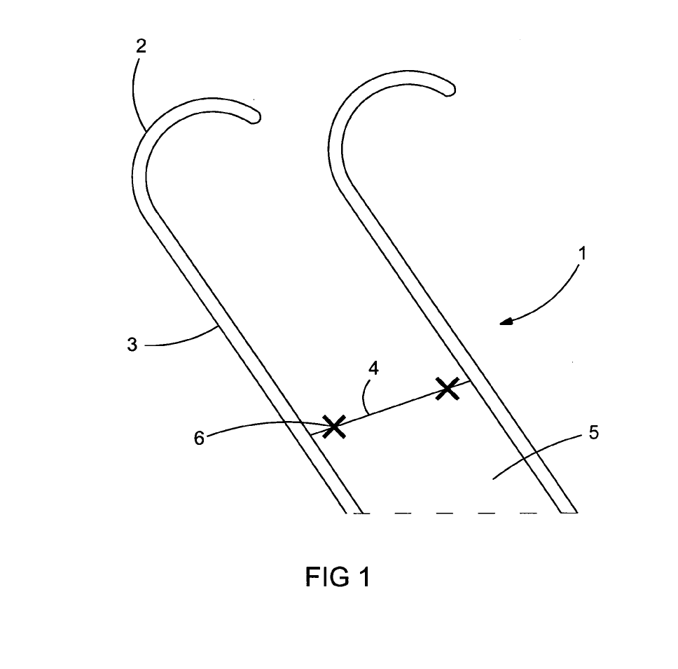

FIGS. 1 to 5 show partial upper views of a pushchair with speakers of the present invention releasably attached thereto in various positions. The positioning of the speakers is indicted schematically by the letter X.

FIG. 1 shows a pair of speakers that are releasably attached to an upper edge of a seat of the pushchair.

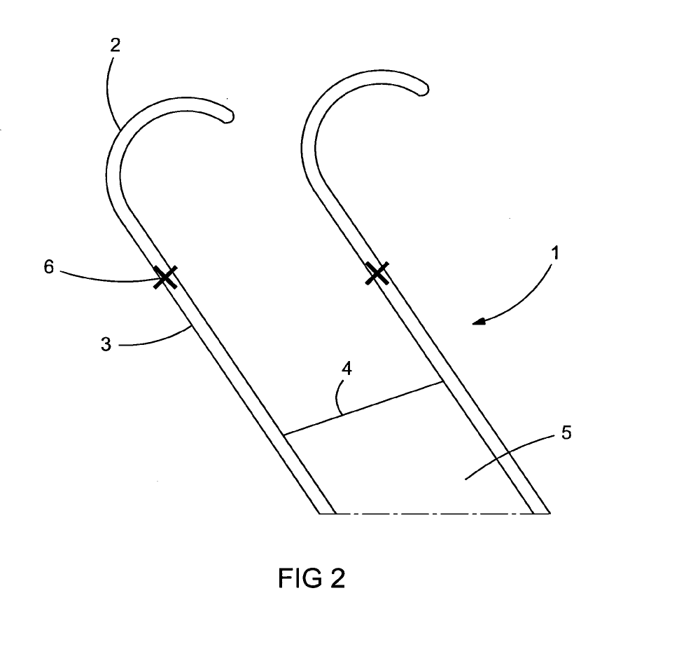

FIG. 2 shows a pair of speakers that are releasably attached to a part of the frame of the pushchair located above the seat and below the handles.

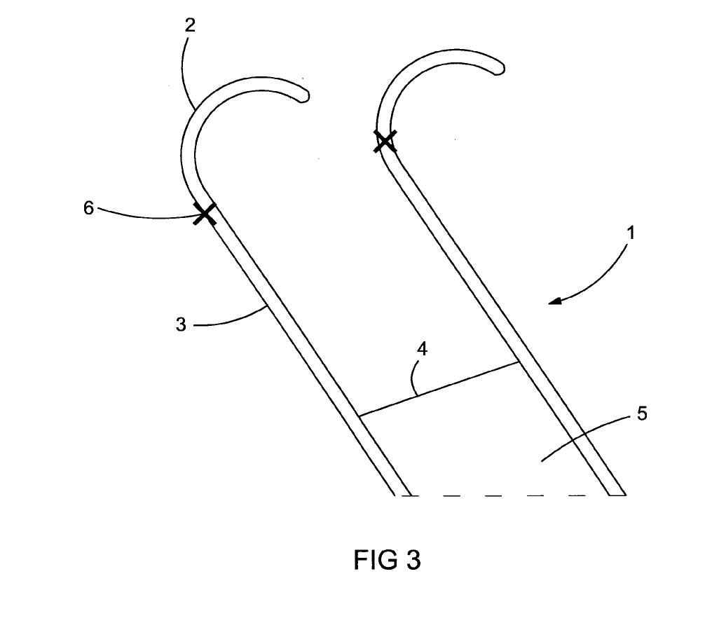

FIG. 3 shows a pair of speakers that are releasably attached to handles of the frame of the pushchair located above the seat and below the handles.

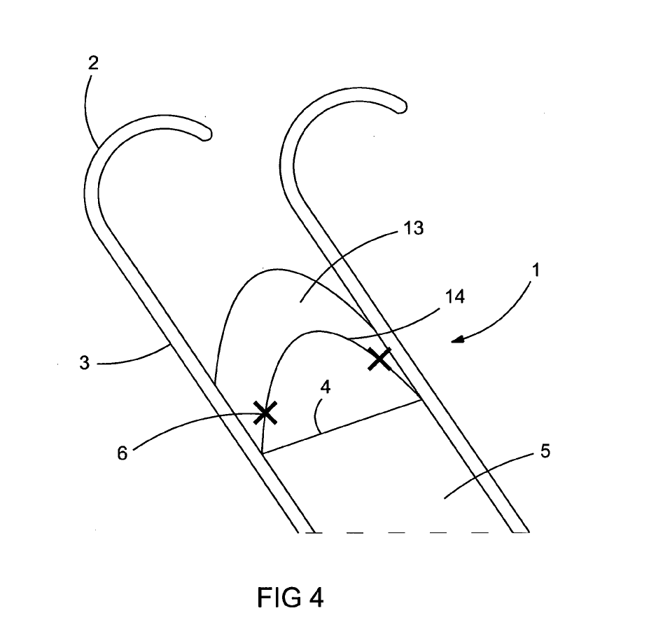

FIG. 4 shows a pair of speaker for use with the present invention that are positioned on a hood of the pram/buggy/pushchair, above the infant's head.

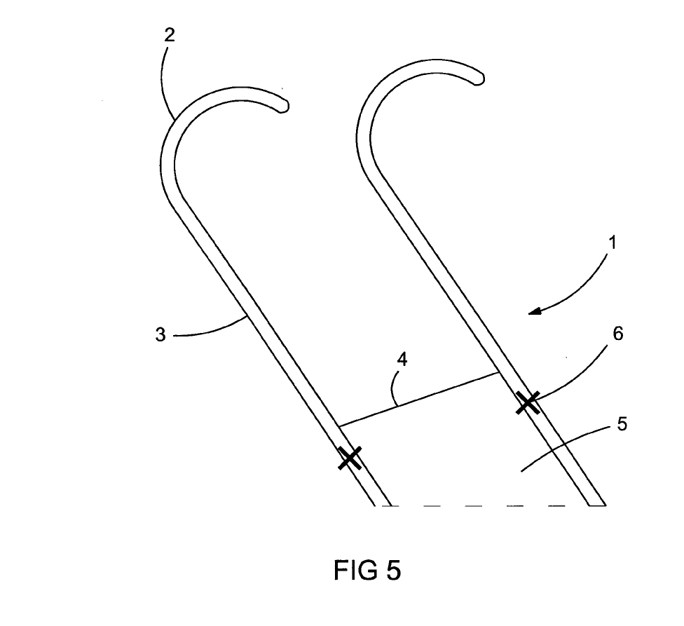

FIG. 5 shows a pair of speaker for use with the present invention that are positioned on the frame of the pram/buggy/pushchair below the top of the seat and alongside the infant's head.

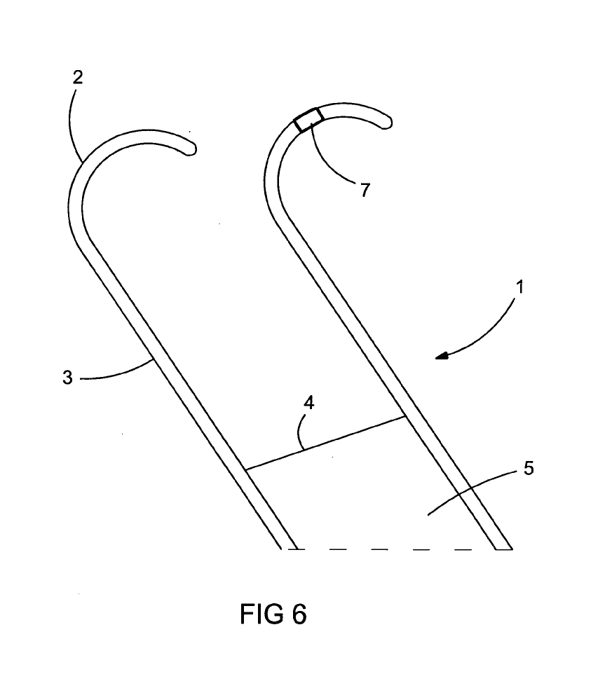

FIGS. 6 to 9 show the positioning of an MP3 device. For simplicity the speakers are not shown in these figures, but they would be releasably attached to the pushchair and operably connected to the MP3 device

FIG. 6 shows an MP3 device that is releasably attached to a handlebar of a pushchair by Velcro™ or by a spring-loaded clip provided on the MP3 player.

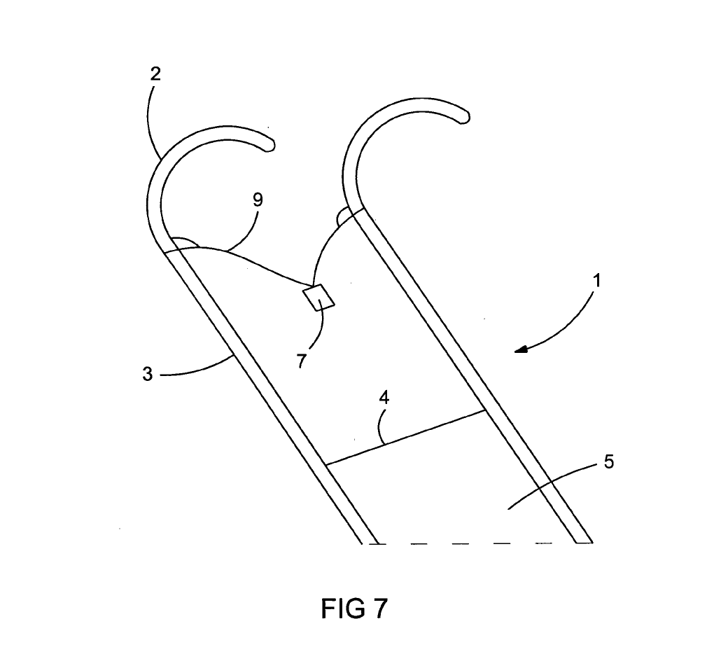

FIG. 7 shows an MP3 device that is releasably attached to two handlebars of a pushchair via ties or straps.

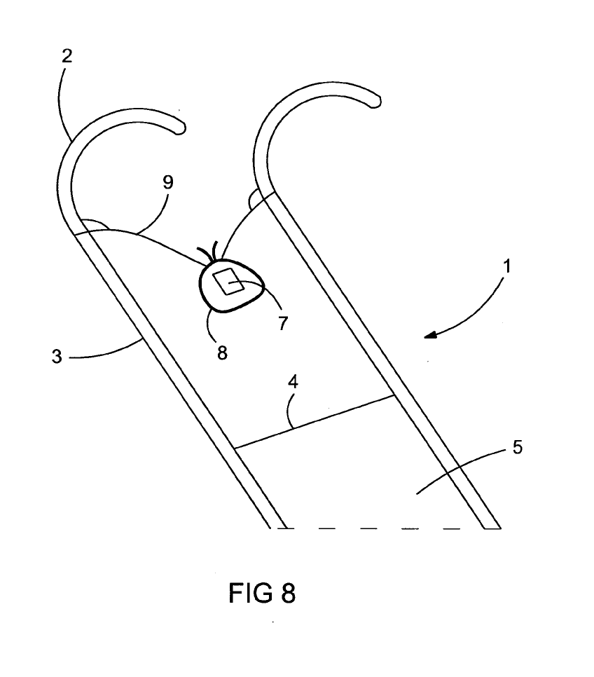

FIG. 8 is similar to FIG. 7, apart from the fact that the MP3 player is within a bag and the bag is attached to the handlebars via straps or ties

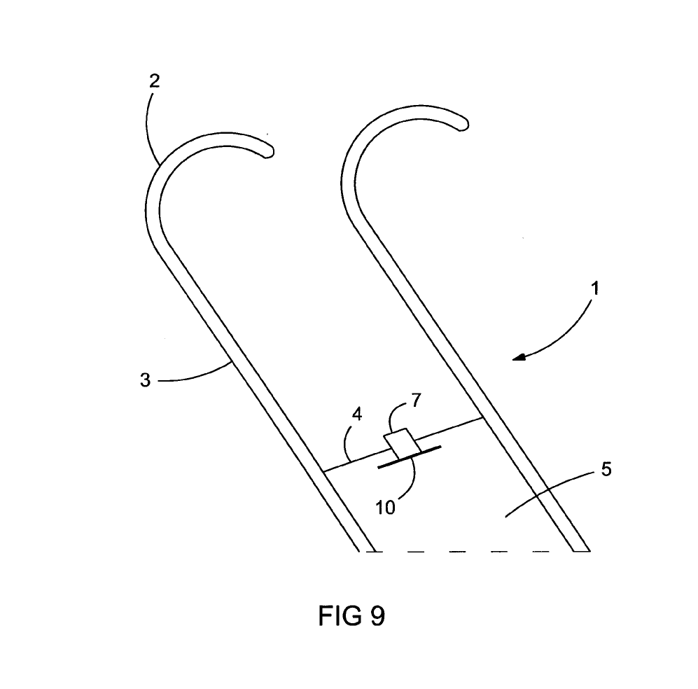

FIG. 9 shows the MP3 player located in a pouch or compartment that is already present in many standard pushchairs. (It is used to stores wipes or other accessories for an infant)

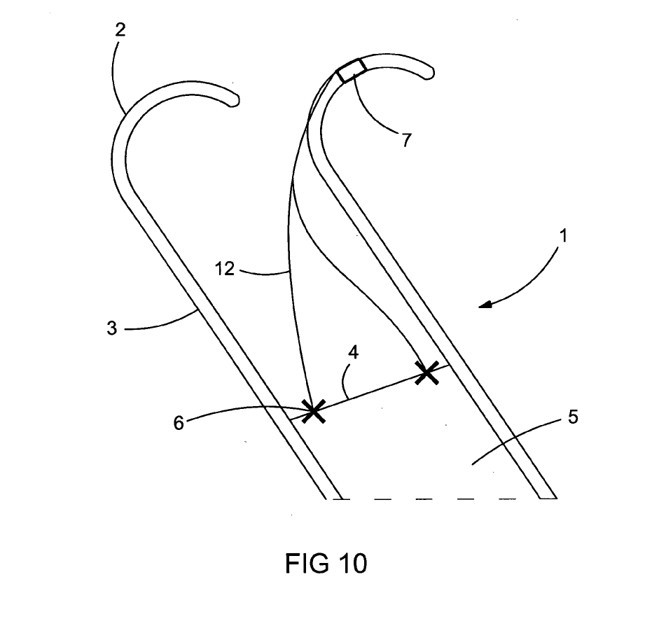

FIGS. 10 to 12 show various combinations of the MP3 player and associated speakers. Many other combinations are of course possible.

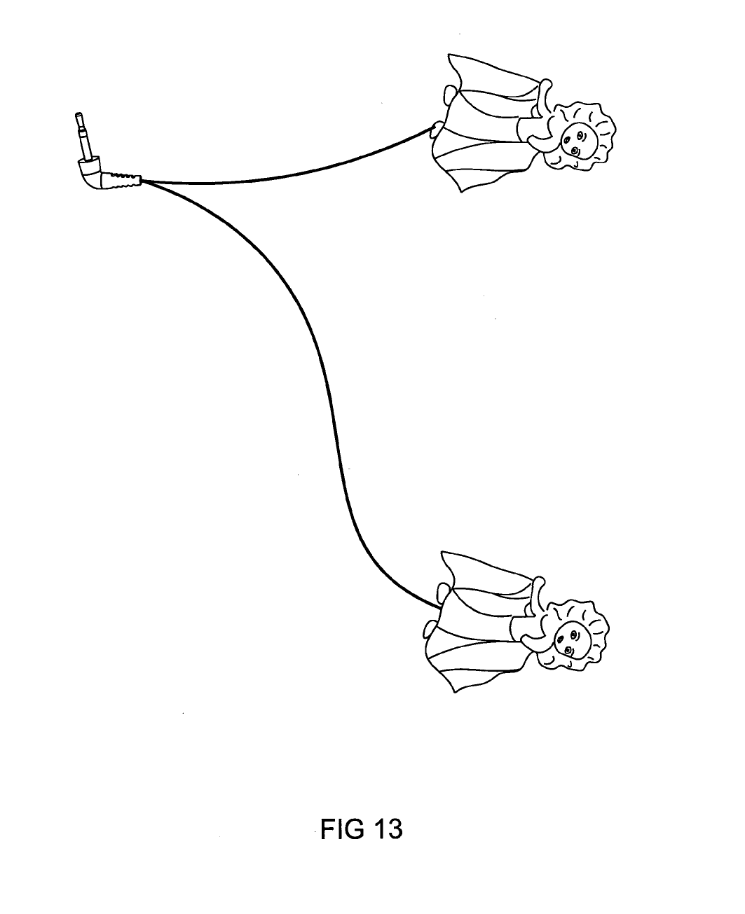

FIGS. 13 to 19 show various novelty speakers.

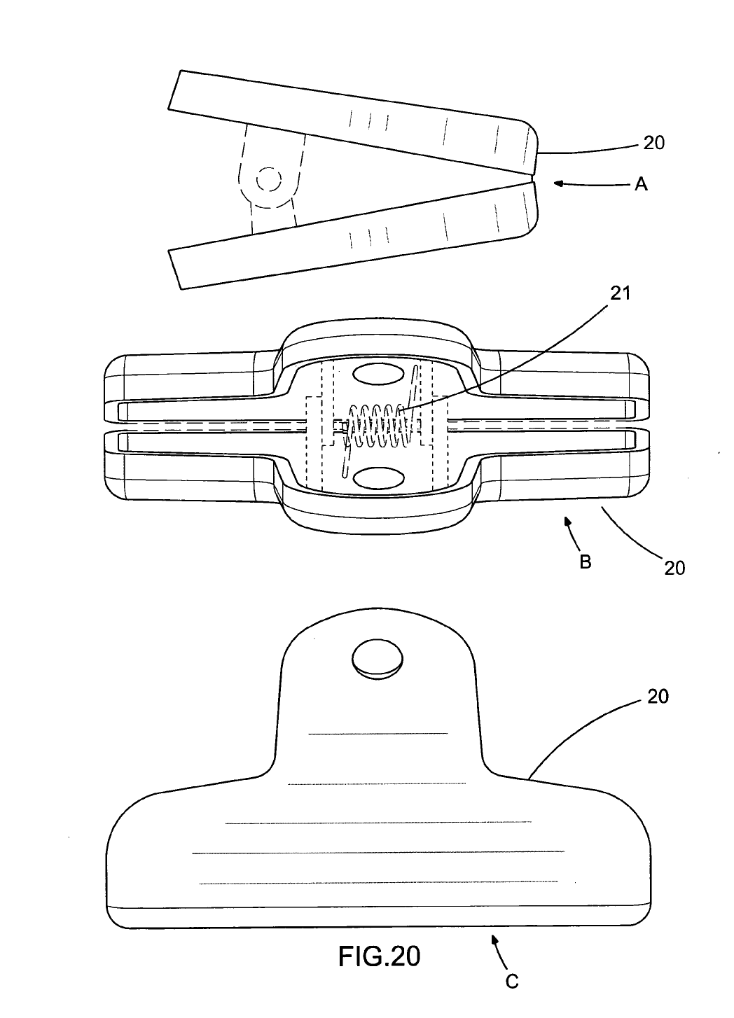

FIG. 20 shows a clip that can be secured to a speaker and used to attach the speaker to a part of the push chair. Different views of the clip are shown in parts A, B and C of this figure.

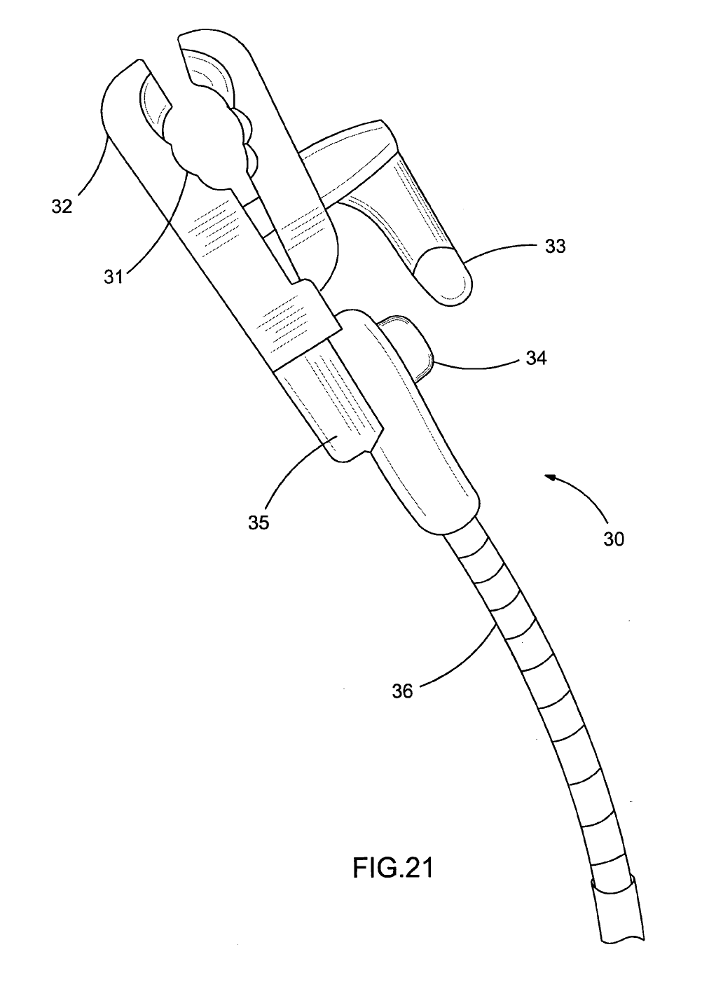

FIG. 21 shows a universal, releasable clamp that can be used to releasably attach a video player to a pushchair and can also be used to vary the position of the screen via an adjustable arm.

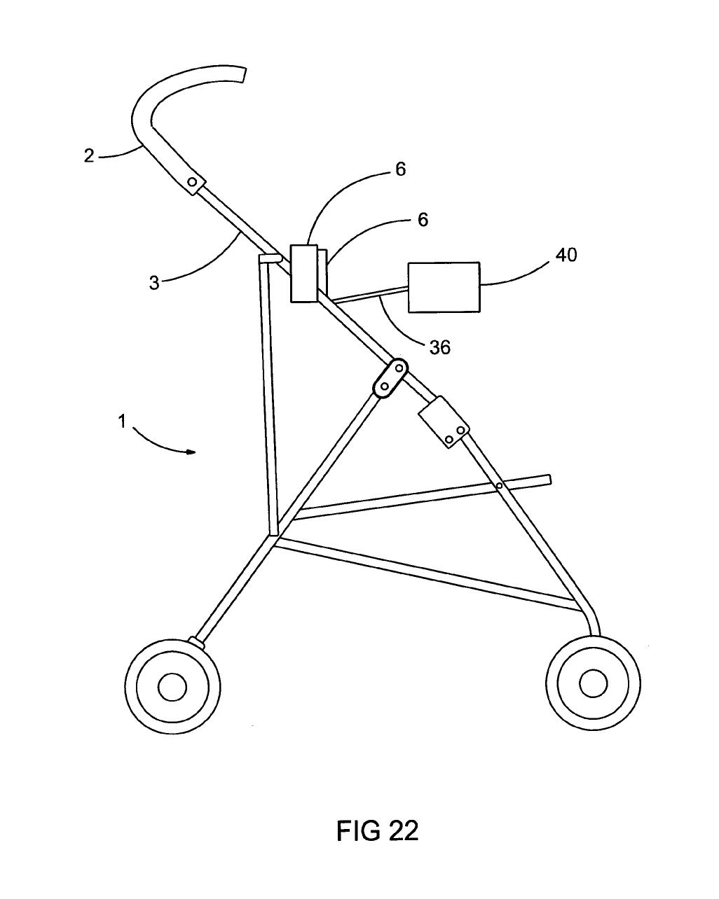

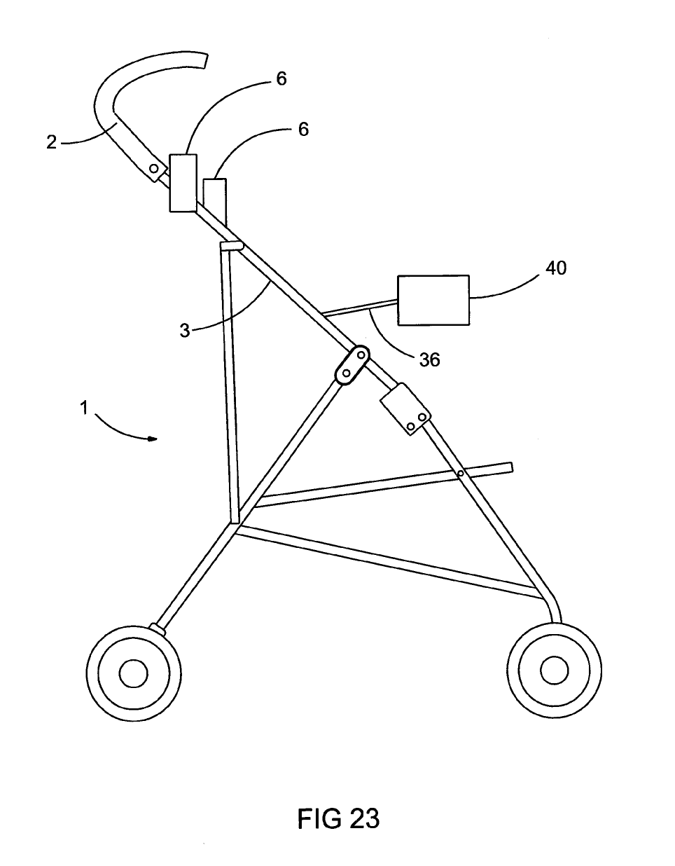

FIGS. 22 and 23 show a screen that is releasably attached to a pushchair via an adjustable arm, with operably associated speakers at different positions.

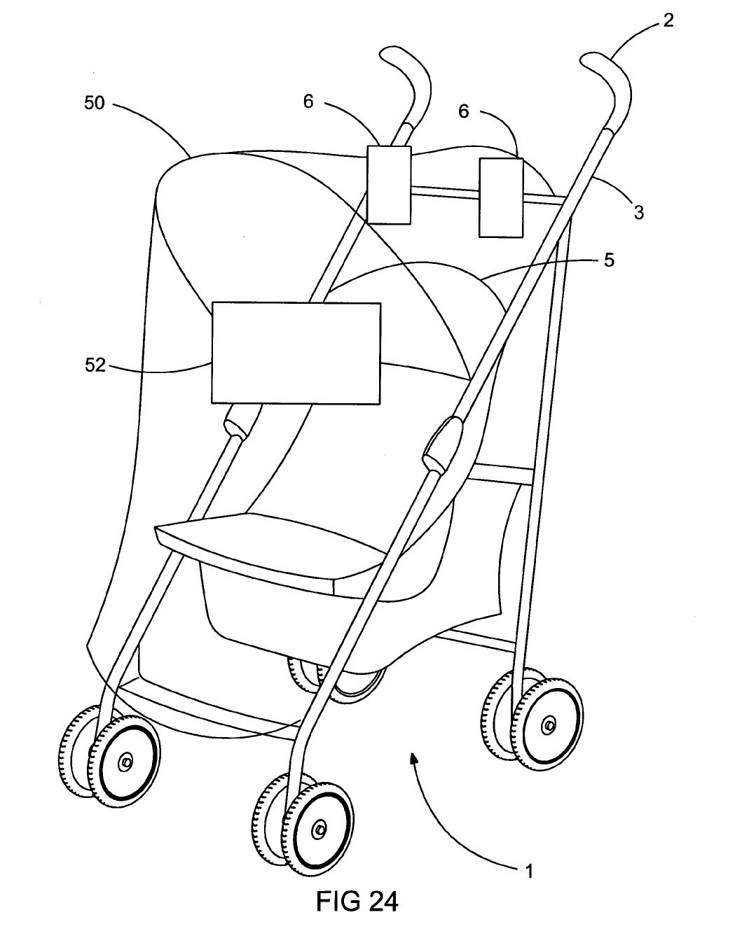

FIG. 24 shows a pushchair with a rain cover; wherein the rain cover has a pocket to support a screen and also pockets to support associated speakers.

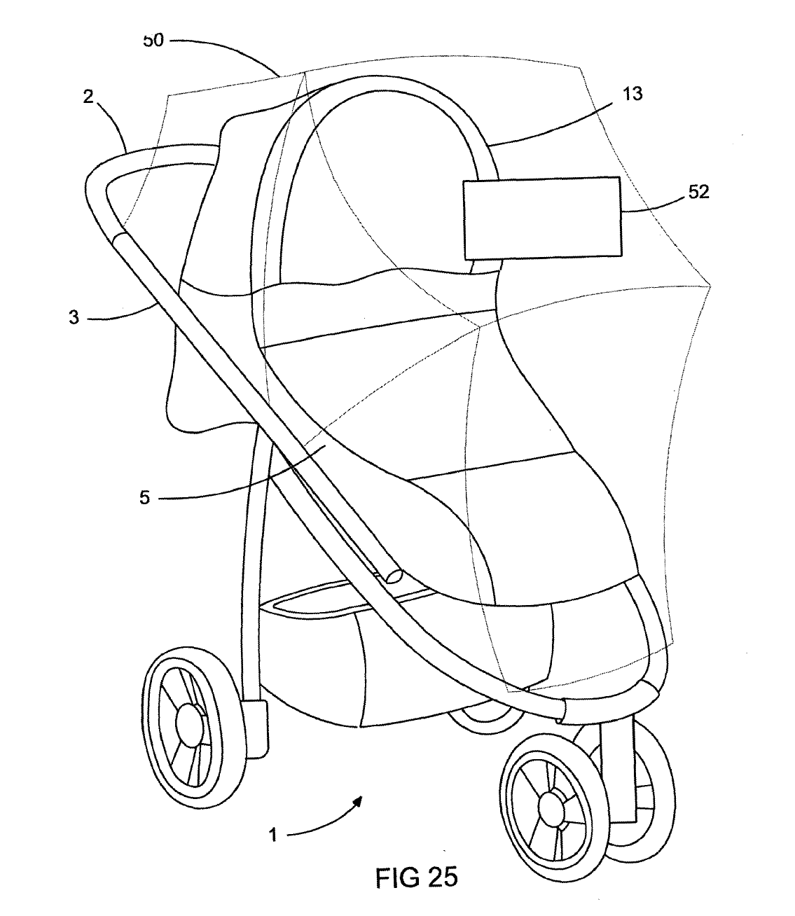

FIG. 25 is similar to FIG. 25, apart from the fact that the screen is part of a unit with its own integral speakers

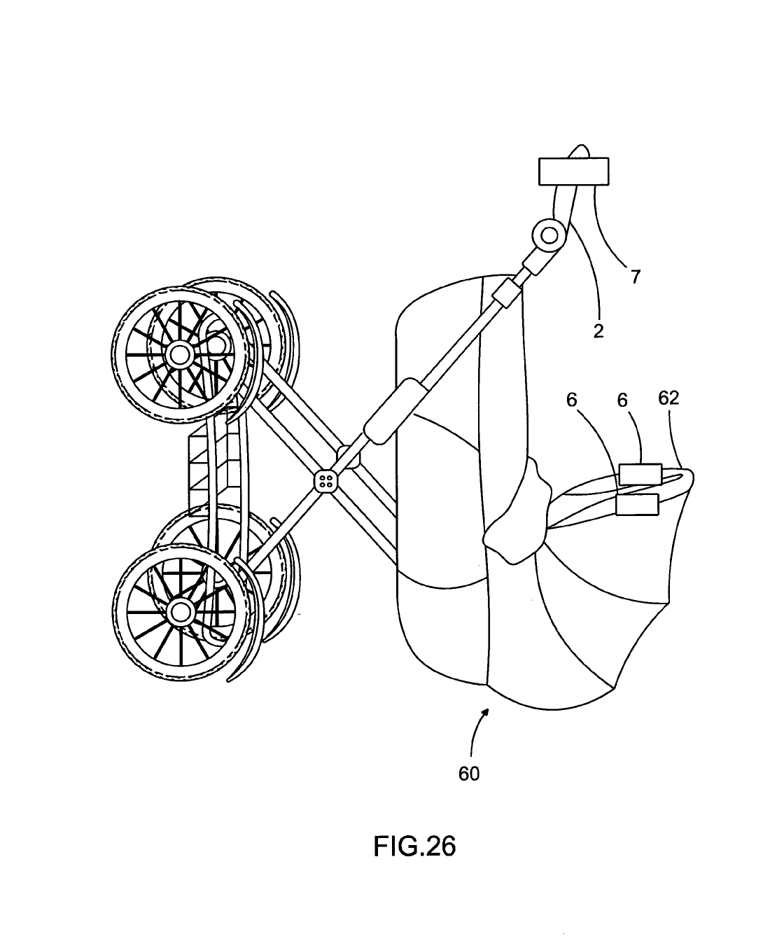

FIG. 26 illustrates the point that the invention can be applied to a pram as well as to a pushchair and shows a pram with a media player releasably attached to the handle and speakers releasably attached to the hood of the pram. Many other positions are of course possible.

### EXAMPLES

The figures illustrate a range of examples of the present invention and are considered below in further detail.

A variety of different positions are shown for speakers 6 of the present invention in FIGS. 1 to 5 when attached to a pushchair 1. The speakers X may be wired or wireless. They are provided with low maximum decibel levels to avoid damage to an infant's ears.

In FIG. 1 the speakers 6 are attached to the top 4 of the seat portion 5 of the pushchair 1. This allows easy access to the speakers by a parent pushing the pushchair 1, whilst making it difficult or impossible for an infant to interfere with the speakers 6 (especially if the infant is strapped into the pushchair 1).

In any event, the speakers 6 can be easily viewed by a parent pushing the pushchair 1 if an infant attempts to interfere with them. They can be conveniently attached by clipping, the use of Velcro™ or by any other releasable attachment means. In this position the speakers 6 can be easily heard by both the parent pushing the pushchair 1 and the infant. This is useful in allowing interaction by the parent with the child in response to what is being played by the MP3 player. For example, the parent and infant may sing together along with a song, may practise a nursery rhyme together, etc. If the speakers 6 have volume controls, these can be easily accessed by the parent.

FIG. 2 is similar to FIG. 1, apart from the fact that the speakers 6 are located on the frame 3 of the pushchair 1 at a position between the handles 2 of the pushchair 1 and the top 4 of the pushchair seat 5. Here the infant will normally not be able to interfere with the speakers 6. The speakers 6 will also be closer to the parent, than in FIG. 1 allowing the parent to hear the MP3 player more easily. The parent can also easily adjust the position of the speakers 6 if desired.

FIG. 3 is similar to the earlier figures, apart from the fact that the speakers 6 are located on the handles of the pushchair 1. Thus they are very accessible to a parent pushing the pushchair 1 and not accessible to the infant. If small speakers 6 are used and or of they are positioned so as to leave a major portion of the handles 2 free for gripping they need not interfere significantly with the function of the handles.

FIG. 4 shows the speakers 6 attached to an edge 14 of a hood 13 of the pushchair 1. Here the speakers 6 will not normally be accessible to the infant, but will be accessible to the parent. Again they provide output that can be heard by both the parent and child.

FIG. 5 shows a pair of speakers 6 for use with the present invention that are positioned on the frame of the pushchair alongside the infant's head.

Here the speakers 6 are attached below the below the top 4 of the seat 5. They are shown attached to the frame 3 at a position level with the head of the infant. This allows the speakers 6 to be easily heard by the infant and also for stereo effects to be fully appreciated. If the infant is strapped into the pushchair 1, it may still be difficult for the infant to interfere with the speakers. 6.

Even if this is attempted, the speakers 6 can be readily seen by a parent who can intervene as appropriate. The speakers 6 in this position can also be heard by the parent, although of course the sound for the patent will be a little lower than for speakers 6 located at higher positions. It is also possible (although less preferred) to locate speakers 6 at lower positions. In any event, one of the major advantages of the present invention is of course that the speakers 6 can be very easily removed and repositioned, if desired.

FIGS. 6 to 9 show various positions of an MP3 player 7. (Of course many other media players be provided and an MP3 player is merely one example.)

In FIG. 6 the MP3 player 7 is clipped to a handle 2 of the pushchair 1 or is attached by Velcro™.

In FIG. 7 ties 9 are used.

In FIG. 8 ties 9 are also used, but are attached to a bag 8 in which the MP3 player 7 is contained, rather than to the MP3 player 7 itself. The ties 9 can also function as drawstrings for the bag 8.

FIG. 9 utilises a pouch 10 that is already present in the pushchair 1 to house the MP3 player 7.

In all of the embodiments illustrated in FIGS. 6 to 9 the MP3 player 7 can be easily removed/released as desired.

This can be particularly important, for example, if it is desired to load new songs onto the MP3 player 7. It is also useful for security. Indeed a large enough bag or other container can be provided, if desired, to house both the speakers and the MP3 player when they are removed. This may even be the same container as a container 8 used to releasably attach the MP3 player to the pushchair 1.

FIGS. 10 to 12 are useful in showing some of the many possibilities for positioning the MP3 player 7 and the speakers 6.

FIG. 10 shows the MP3 player 7 shown in FIG. 6 when connected to speakers 6 in the location shown in FIG. 1.

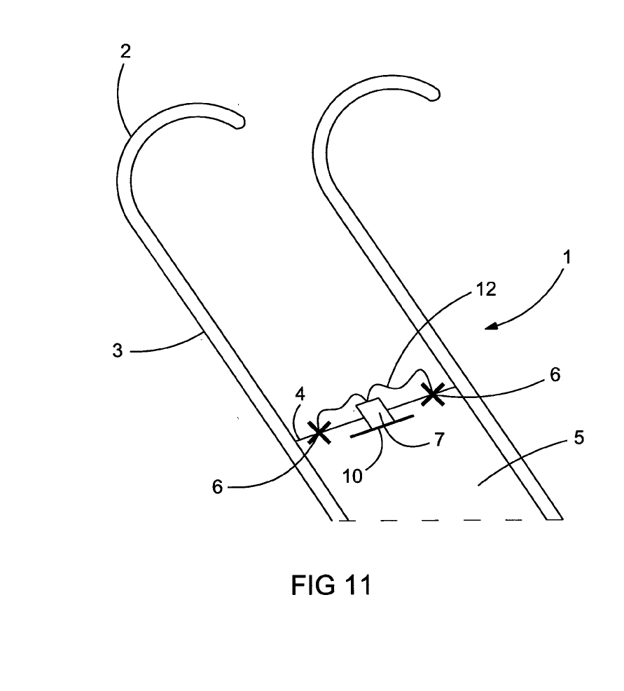

FIG. 11 shows the MP3 player 7 shown in FIG. 9 when connected to speakers 6 in the location shown in FIG. 1.

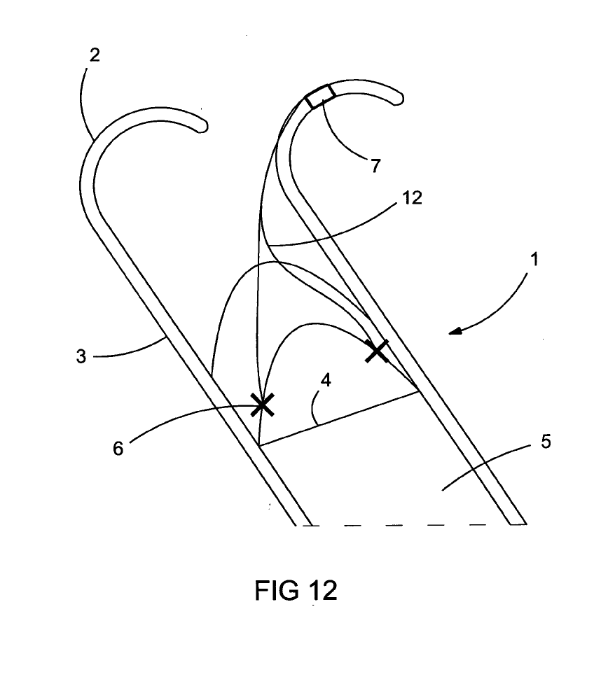

FIG. 12 shows the MP3 player 7 shown in FIG. 6 when connected to speakers 6 in the location shown in FIG. 4.

FIGS. 13 to 19 show various novelty speakers, where the speakers are disguised as other items that appeal to infants.

FIGS. 13 to 15 are examples of novelty speakers that may appeal particularly (although not necessarily exclusively) to boys.

Here FIG. 13 shows a pair of novelty speakers for use with the present invention; wherein the novelty speakers are disguised in the form of dolls that comprise small apertures (not shown) through which sound can be emitted

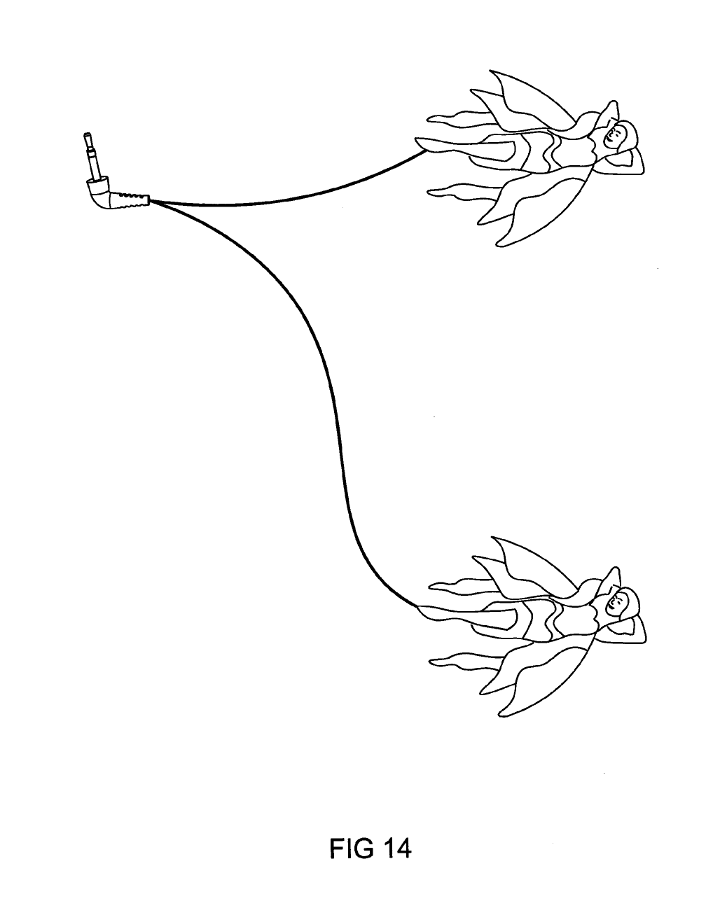

FIG. 14 shows a pair of novelty speakers for use with the present invention; wherein the novelty speakers are disguised in the form of fairies that comprise small apertures (not shown) through which sound can be emitted

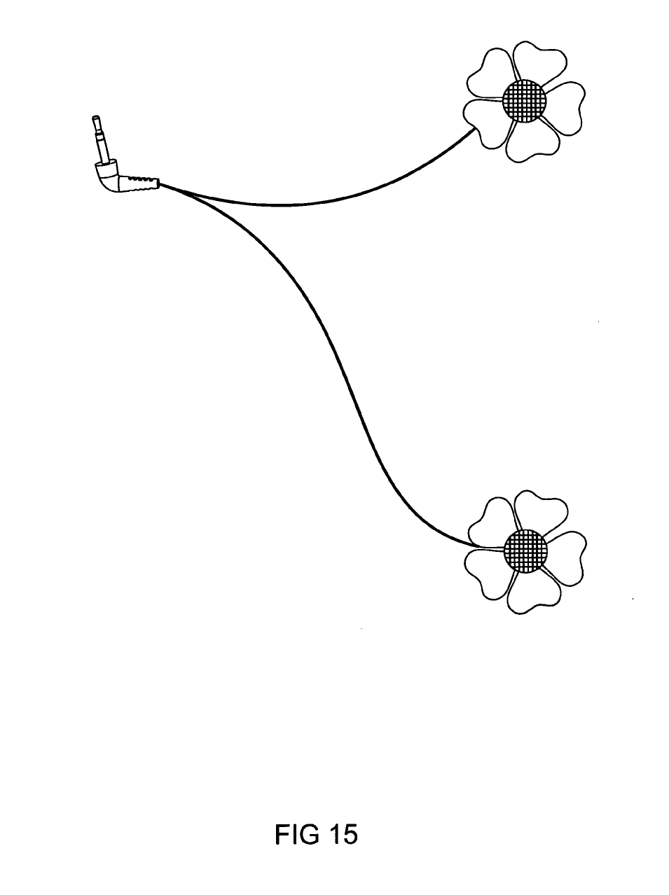

FIG. 15 shows a pair of novelty speakers for use with the present invention; wherein the novelty speakers are disguised in the form of flowers, with sound being emitted through a mesh the centres of the flowers.

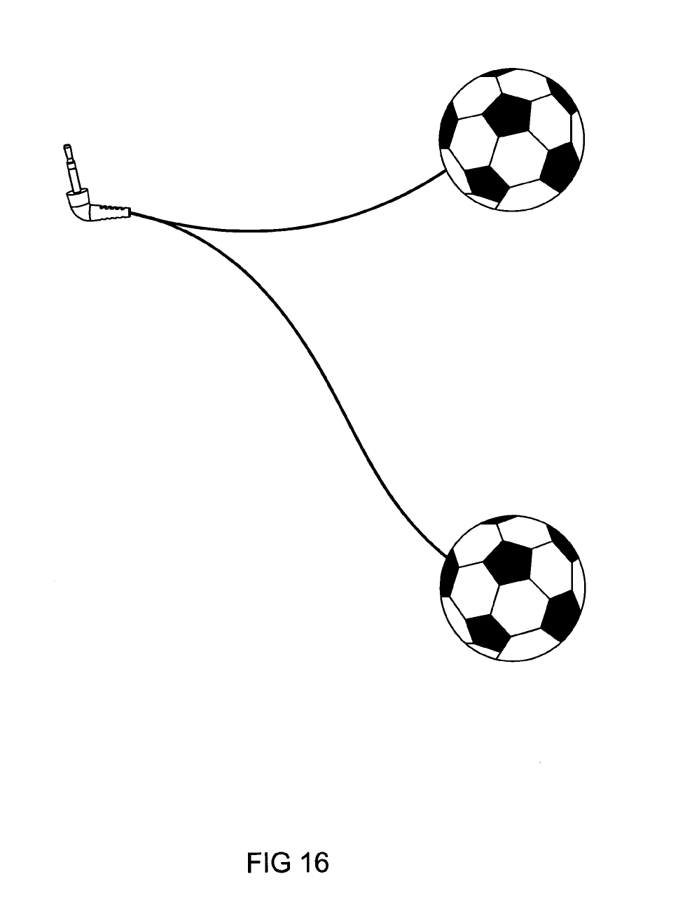

In contrast, FIGS. 16 to 18 are examples of speakers that may appeal particularly (although not necessarily exclusively) to boys.

FIG. 16 shows a pair of novelty speakers for use with the present invention; wherein the novelty speakers are disguised in the form of footballs that comprise small apertures (not shown) through which sound can be emitted

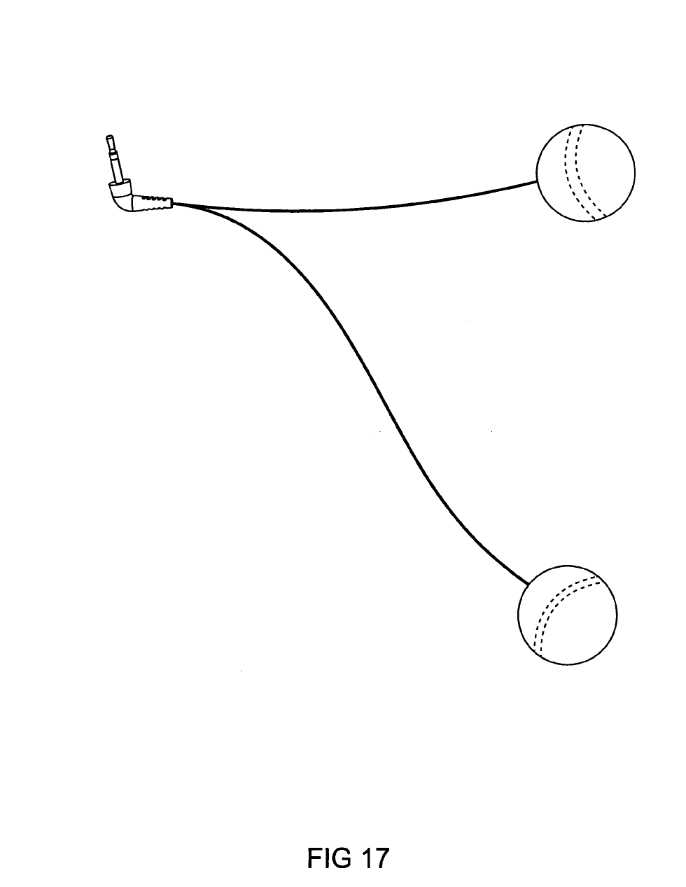

FIG. 17 shows a pair of novelty speakers for use with the present invention; wherein the novelty speakers are disguised in the form of cricket balls that comprise small apertures (not shown) through which sound can be emitted.

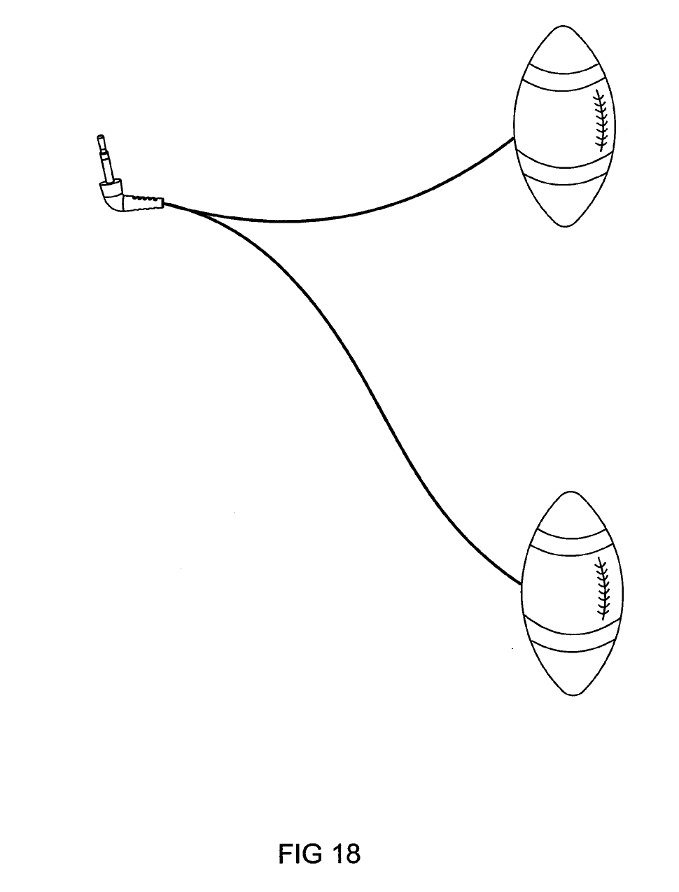

FIG. 18 shows a pair of novelty speakers for use with the present invention; wherein the novelty speakers are in the form of rugby balls that comprise small apertures (not shown) through which sound can be emitted

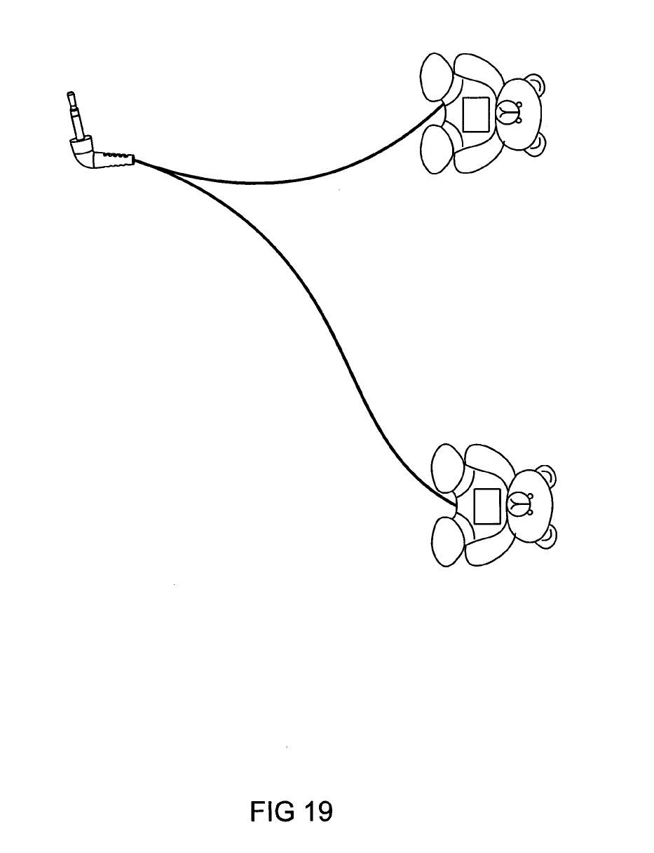

FIG. 19 is an example of speakers that may appeal particularly both sexes. This is a teddy but is not he same as an I-Teddy because the MP3 player is not integrated into the teddy but is located separately.

The novelty speakers shown in FIGS. 13 to 19 can be formed of any suitable materials or combinations thereof.

For example, moulded plastics material, fabrics, metals etc may be used. In some cases the novelty parts of speakers may be removable and interchangeable (e.g. as removable covers). Kits comprising different speakers and/or or different covers may be provided. Apertures may be provided if necessary.

FIG. 20 shows an example of a clip 20 that may be used to attach speakers and/or an MP3 player to a pushchair. The clip may be built into the speakers or may be attached thereto (e.g. via ties, adhesive, tape etc.) Parts A, B and C of the figure show side, rear and front views of the clip 20 respectively. The clip is essentially a spring-loaded bulldog clip of an appropriate size to attach to the pushchair and sufficient strength to support the MP3 player. The spring 21 is shown in part B in dotted lines

FIG. 21 shows a clamp 30 that can be used to support heavier items than a small MP3 player e.g. a DVD player. It comprises concave inner surfaces 31 that can fit around and grip around tubular regions of a frame 3 of a pushchair 1. It also has opposing inner faces 32 that can grip other regions (e.g. upholstery). A lever 33 is provides that can be turned to adjust the clamp 30 so it can grip different sized frames or different thicknesses of materials. A pivot point 35 is also provided, as well a knob 34 that can be screwed down to maintain a desired angle of pivot, or can be unscrewed to allow pivoting. A deformable arm 36 is attached to the pivot point 35. Thus a wide range of adjustments are possible.

FIGS. 22 and 23 show a screen 40 that is releasably attached to a pushchair 1 via a clamp 30 with an adjustable arm 36 as shown in FIG. 21. Also shown are speakers 6 that are releasably attached to the frame 3. FIG. 22 shows the speakers and screen relatively close to one another, whilst FIG. 23 shows them further apart. The screen can be used to display images, whether moving or still. For example it may be a DVD player a video player, an MP4 player, a TV, it may display photographs etc. A wide variety of possibilities exist.

FIGS. 24 and 25 illustrate rain covers 50 of the present invention comprising media players with screens 52 located in in-built pockets The pockets can either be on the inside or outside of the rain covers 50 and are preferably translucent/transparent and waterproof. (For ease of reference the pockets are not shown.) As an alternative to pockets, any other means for holding the media player 52 in position can be used (e.g. straps, ties, clips etc). As can be seen from the figures the rain cover 50 allows the screen 52 to be very conveniently positioned for viewing by an infant in a carrier 1 that is covered thereby.

In FIG. 24 operably associated speakers 6 are shown that are located elsewhere on the rain cover 50 (e.g. via attachment means or via additional pockets). Alternatively, the speakers 6 could be releasably attached to the infant carrier 1, e.g. to a frame 3, seat 5, handles 2, or a hood 13, if present. (See FIG. 25 for an illustration of an infant carrier with a hood.)

FIG. 25 shows a further alternative within the scope of a present invention in which the media player with a screen 52 comprises its own speaker(s) and additional speakers are therefore not needed. Thus here the media player and integral speaker(s) are therefore within the same pocket. (Even if they are separate components then it may still be convenient to place speakers and media player within the same pocket.)

FIG. 26 illustrates the point that the invention can be applied to a pram 60 as well as to a pushchair 1 and shows a pram 60 with an MP3 player 7 releasably attached to the handle 2 and speakers 6 releasably attached to the hood 62 of the pram 60. Many other positions are of course possible. Screens and/or rain covers may alternatively be used as described for pushchairs 1. The pram 60 is shown here with its hood 62 facing the handle 2 and remote from the handle. An alternative arrangement of the pram is of course possible in which the hood 62 is much closer to the handle 2 and facing away therefrom. This is also within the scope of the present invention.

1-55. (canceled)

56. An infant carrier that comprises an electronic media player and one or more speakers that are spaced from, but operably connected to, the media player; wherein the one or more speakers are not integrated into the infant carrier, but are releasably attached thereto by one or more releasable attachment mechanisms.

57. An infant carrier according to claim 56; wherein the one or more releasable attachment mechanisms are quick release mechanisms.

58. An infant carrier according to claim 56; wherein the attachment mechanism for each speaker allows single handed release of the speaker from the carrier.

59. An infant carrier according to claim 56; wherein the one or more speakers are releasably attached to the infant carrier using one or more of the following: clips, clamps, ties, straps, bands, hook and eye fasteners, magnets, press or push fittings.

60. An infant carrier according to claim 56; wherein the one or more speakers and/or media player are positioned at a height that is above the level of a head of an infant transported by said carrier, or is at least not below the level of a head of an infant transported by said carrier.

61. An infant carrier according to claim 56; wherein the one or more speakers and/or the media player are positioned to be accessible to a person using the infant carrier to transport an infant and/or but not to be accessible to an infant in the carrier.

62. An infant carrier according to claim 56; wherein the one or more releasable attachment mechanisms are shaped for attachment to:
(i) a frame or a handle of the carrier;
(ii) a seat or upholstery of the carrier; or
(iii) a hood of the carrier.

63. An infant carrier according to claim 56; wherein the one or more speakers are in disguised form or in novelty form.

64. An infant carrier according to claim 56; wherein the one or more speakers are in the form of one or more of the following: a fictional or non-fictional character; a sporting item, emblem or badge; a toy; an animal or plant; a vehicle.

65. An infant carrier according to claim 56; wherein the one or more speakers are in the form of one or more of the following: a fairy, a doll, a teddy bear, a monster, a cowboy, an indian, a soldier, football, a rugby ball, a cricket ball, a flower, a car, a plane, a boat.

66. An infant carrier according to claim 56; wherein the output of the one or more speakers is limited or muffled so as to be suitable for safe hearing by an infant.

67. An infant carrier according to claim 56; wherein the media player provides media content for an infant.

68. An infant carrier according to claim 56; wherein the media player provides songs, stories, rhymes, videos or educational content for an infant.

69. A kit comprising one or more speakers having releasable attachment mechanisms for attachment to an infant carrier and a media player and instructions for use in releasably attaching the one or more speakers to the infant carrier.

70. A kit according to claim 69; wherein the instructions for use further comprise instructions for use in connecting the one or more speakers to the media player if they are not already so connected.

71. A kit according to claim 69 wherein the one or more speakers comprise a releasable attachment mechanism shaped for attachment to:
(i) a frame or a handle of the carrier;
(ii) a seat or upholstery of the carrier; or
(iii) a hood of the carrier.

72. A kit according to claim 69; wherein the releasable attachment mechanism is a quick release mechanism.

73. A kit according to claim 69; wherein the attachment mechanism for each speaker allows single handed release of the speaker from the carrier.

74. A rain cover for an infant carrier comprising:
a) a compartment for a media player, or a mechanism for releasably attaching the media player to the rain cover and/or
b) one or more compartments for one or more speakers, or a mechanism for releasably attaching the speaker(s) to the rain cover.

75. A rain cover according to claim 74 that comprises a pocket for a media player and/or one or more pockets for one or more speakers.
